(19) United States
(12) Patent Application Publication
(10) Pub. No.: US 2007/0297285 A1
(43) Pub. Date: Dec. 27, 2007

(54) Fractal distributor for two phase mixing

(76) Inventors: William M. Cross, Seabrook, TX (US); Kenneth Peterson, Twin Falls, ID (US); Vadim Kochergin, Twin Falls, ID (US); Mitchell E. Loescher, Houston, TX (US)

Correspondence Address: OSHA LIANG LLP / CDTECH, 1221 MCKINNEY STREET, SUITE 2800, HOUSTON, TX, 77010, US

(21) Appl. No.: 11/473,743

(22) Filed: Jun. 23, 2006

(51) Int. Cl. B01F 5/06

(52) U.S. Cl. 366/340

(57) ABSTRACT

A fractal fluid distribution system for use in a vessel is described wherein two phases are distributed separately and then finally mixed in a set of stacked fractal plates which are off set from one another by rotation around a central axis. Each of the two phases is fed from the top of the vessel. The flow paths of each individual phase have approximately the same length. A header is provided to allow feeding the two phases separately without interference with the final distribution outlets.

### BACKGROUND OF THE INVENTION

1. Field of the Invention

The present invention relates to a system for scaling and distribution of fluids. More particularly the invention relates to a fractal distribution/mixing system for mixing and distributing two separate phases. More particularly the invention relates to a single fractal distributor which distributes two fluid phases independently until the final distribution points are reached.

2. Related Information

Fluid transporting fractal structures (“fractals”) have recently become available for the control of fluid flow. U.S. Pat. No's. 5,354,460 and 6,616,327, describe fractal structures embodied as fluid distributors/collectors. A notable characteristic of the device disclosed by the '460 patent is its recursive scaling configuration which is, for purposes of this disclosure, regarded as a “fractal”. This fractal configuration provides exceptionally even fluid flow distribution. U.S. Pat. No's. 5,354,460 and 6,616,327, are incorporated by reference herein.

PCT/US97/17516, the disclosure of which is incorporated by reference herein, describes the use of space filling fluid transporting fractals as alternatives to the scaling and distribution function of turbulence.

“Fractal scaling,” as contemplated by this invention, is a recursive process by which an algorithm is applied in successive stages, each time to process the outputs from an immediately preceding stage. A simple case for purposes of illustration is to apply the algorithm to “divide a flow stream into two equal flow streams.” According to this example, a flowing stream is divided into two equal streams of half the initial volume during a first stage. Each of the two resulting streams is then similarly divided to produce a total of four equal streams of reduced volume in a second stage. Those four resulting streams are then divided into eight equal streams of reduced volume in a third stage, and soon, through as many stages as are desired to achieve the distribution of fluid flow required for a particular application.

Mathematical models of fractal geometry assume that each division at each stage is identical and that precisely identical geometry is followed through each branch of successive stages. In practice, it is recognized that absolute adherence to a mathematical model is impractical. Accordingly, fractal devices are usually constructed to approximate a theoretical model. That is, because of manufacturing and space constraints, commercial fractals often make use of “similar”, rather than “identical” fractal patterns. This disclosure should be understood within that context. The practical consequences of this departure from theoretical are generally minimal within the practical realm.

Fractals may be constructed as an entire device, or multistage segment of such a device, as a unitary structure, e.g., through investment, shell or lost wax casting techniques. Multilevel fractals are more conveniently provided, however, through the use of a stack of fractal elements in an assembly, or “fractal stack.” To avoid redundancy of description, this disclosure gives primary emphasis to fractal stacks utilized as distributors.

The individual elements of a typical fractal stack are three-dimensional components, structured and arranged for juxtaposed assembly in a specified sequence. Each fractal element is provided with channels and ports constituting a portion of a fractal fluid scaling array. Various portions of the scaling array may be assigned to individual elements, those portions being selected such that a practical recursive fractal array results from the assembly of the elements, in proper sequence, into the fractal stack. A presently preferred arrangement assigns the fluid flow channels of a specified fractal stage to a single specified fractal element. It is within contemplation to assign channels of different fractal stages to a single fractal element, and it is also within contemplation to divide channels of a specified fractal stage among a plurality of fractal elements. The channels associated with a particular element may be positioned on a single side or on the opposed sides. In the latter case, the channels of a fractal stage may be defined by juxtaposed matching grooves at the interfaces between adjacent elements.

An exemplary fractal element has a relatively large cross section normal to the direction of fluid flow to accommodate the largest fractal pattern in the stack. This pattern is typically that of the final fractal stage, and its “footprint” is dependent upon (among other things) the fractal number (the number of stages) accommodated by the stack. A relatively small height dimension is required to accommodate flow channels arranged in a fractal pattern within, (most often openly communicating with either or both interfacing surfaces of the element). Such elements take the form of short prisms, usually cylindrical and are designated “fractal plates,” for purposes of this disclosure and may be arranged in a cylindrical vessel for use. Fractal plates may be stacked upon one another such that fractal distribution to progressively smaller scales occurs as fluid passes through the stack. The device therefore acts as a fluid distributor. Near limitless scaling of fluid motion can be accomplished with this invention by the addition of fractal plates to the stack, that is, by increasing the fractal number of the stack.

Most often, portions of the fractal pattern are provided on structural elements assembled in stacked arrangement with respect to each other. The structural elements are typically, approximately congruent geometric solids with flow channels arranged therein. The invention is thus applied in practice to a fractal fluid system in which recursive flow paths are arranged in a fractal pattern including generations of progressively increasing or decreasing scale. The improvement of the invention generally comprises providing portions of the fractal pattern in stacked arrangement with respect to each other, whereby to avoid intersection of recursive flow channels. The generations of progressively increasing or decreasing scale are typically positioned between an inlet and an outlet, whereby to modify the scale of fluid flow through the system. The present invention successively arranges such generations of structural flow channels at different distances from the inlet in the direction of the outlet in conformance to the fractal pattern so as to constitute fractal elements. Ideally, these fractal elements comprise plates which contain fractal patterns, one stacked upon another, to provide a fractal stack constituting a means for fluid distribution at progressively different scales as fluid passes through the stack from its inlet to its outlet. The inlet may be located to direct fluid to either the largest or smallest scale fractal generation.

Particularly when the stack is operated as a distributor, it may include a finishing structure at one (outlet) end, structured and arranged to promote even distribution of fluid normal to the direction of fluid flow through the stack. The finishing structure is preferably constructed and arranged to provide multiple channel tortuous pathways for fluid exiting the fractal pattern. The opposite (inlet) end of the stack may comprise a structural element containing distribution channels arranged to receive fluid from a primary inlet and to distribute scaled quantities of that fluid to respective inlets of a first generation of the fractal pattern.

Because fractals are, by definition, invariant to scaling, this invention can be used for any size application and still provide any desired range of fluid scaling. This device theoretically enables infinite scaling of fluids. The existing limits on manufacturing objects of very large or very small size impose practical limits upon sizing at present. It is understood, however, that as manufacturing methods for constructing large or small objects improve, those methods can be applied to expand the practical range of scaling offered by this invention.

### SUMMARY OF THE INVENTION

Briefly the present invention herein comprises providing a single fractal distributor which distributes two fluids independently up until they are combined at the final outlet. This is achieved by providing independent fractal flow channels up until reaching the final drip points of the last layer of fractal plates. The main problem associated with the system is that the overhead piping for the two separate fluids may interfere with the final drip pattern. Preferably, in the present system, one of the fluids enters the final fractal plate from below. Interference with the piping is avoided by offsetting the second fluid distribution header such that the downward piping passes between the fractal plates. A mathematical formula for the degree of offset from the radius is based upon the circumference and number of plates.

The present fractal fluid distribution system comprises:

a plurality of first plates, each of said first plates having a first inlet in the approximate geometric center thereof and connected to at least two first outlets by first flow paths having approximate equal length;

a plurality of second plates stacked below said plurality of first plates, each of said second plates having second inlets in communication with said first outlets, each of said second inlets connected to at least two second outlets by second flow paths having approximate equal length, each of said second plates having a third inlet in the approximate geometric center and connected to each of said second flow paths; said plates being offset from one another by rotation around a central axis;

a first conduit central to said vessel having a plurality of second conduits fractally connected to each of said first inlets; and

a third conduit central to said vessel having a plurality of fourth conduits fractally connected to each of said third inlets.

The fractal fluid distribution system may preferably have the first and second inlets on the upper surface of said plates and the third inlet on the lower surface of the second plate. In a preferred configuration the fractal fluid distribution system has the final fractality of the second plurality of conduits offset from the first fractality of the plurality of conduits such that each of the fourth plurality of conduits pass between the stacks of the first and second plurality of plates. In some embodiments the fractal fluid distribution system employs more than two pluralities of plates stacked together.

### BRIEF DESCRIPTION OF THE DRAWINGS

FIG. 1 is a top plan view of an acid predistributor plate according to the invention.

FIG. 2 is a bottom plan view of an acid predistributor plate according to the invention.

FIG. 3 is a bottom plan view of an acid predistributor plate according to the invention with the insert removed and showing the flow channels.

FIG. 4 is a top plan view of a final acid distribution plate according to the present invention.

FIG. 5 is a bottom plan view of a final acid distribution plate according to the present invention.

FIG. 6 is a bottom plan view of a final acid distribution plate according to the present invention with an insert removed to shown the flow channels.

FIG. 7 is a bottom plan view of a hydrocarbon distribution plate according to the present invention.

FIG. 8 is a top plan view of a hydrocarbon distribution plate according to the present invention.

FIG. 9 is a top plan view of a hydrocarbon distribution plate according to the present invention win the insert removed to show the flow channels.

FIG. 10 is a top plan view of a plate assembly comprising the acid predistributor plate, final acid distributor plate and hydrocarbon distributor plate.

FIG. 11 is a bottom plan view of a plate assembly comprising the acid predistributor plate, final acid distributor plate and hydrocarbon distributor plate.

FIG. 12 is a top plan view of the initial piping for one phase of the present invention.

FIG. 13 is a top plan view of the final piping for one phase of the present invention.

FIG. 14 is a top plan view of one section showing the final piping for two phases of the present invention.

### DESCRIPTION OF THE PREFERRED EMBODIMENT

The present invention encompasses the discovery of an energy efficient device for initial co-current upflow or downflow distribution of two fluids into a reactor or mixing vessel. The specific design is particularly applicable for efficient mixing of viscous fluids. This is applicable to large scale two phase mixing and/or reacting systems or for co-introduction of reactants into a vessel utilizing a single distributor. Some examples of two phase mixed and reacting systems include: the cold acid (sulfuric or hydrofluoric acid) alkylation of olefins with iso-paraffins and metals extraction utilizing an immiscible organic and aqueous phase. One of the fluids could be catalytic in nature, such as a slurry phase catalyst. Additionally, the distributor can be used for initial combination of individual reactants at the outlet of the distributor. For these and other similar applications the processes require uniform distribution of both fluids over a large area. The combination of this two-phase distributor described herein in combination with static mixing devices for the purposes of efficient mixing on a large scale is envisioned. As compared to WO 02/092207 the distributor of the present invention is contemplated to be used with a packed bed of material, structured packing or another static mixer device to provide additional mixing for liquid/liquid or gas/liquid contact. The invention eliminates much of the complexity involved with three dimensional scaling and allows for a cost effective and energy efficient means of mixing.

The distributor herein stems from the same basis as U.S. Pat. No. 6,616,327 which incorporated by reference herein in its entirety, in which fractal patterns are utilized. To increase the number of distribution points per square foot of distributor, the fractal pattern is repeated on the next layer of distribution. Each layer of distribution is typically a formed, shaped or cut out plate. For a fractal distributor, in which each fractal plate contains enough fractal elements to expand its number of inlets, each into 6 fractal branches, feeding 6 separate outlets and maintains the same geometric arrangement on a plate by plate basis, the number of distribution drip points goes up as n^{m} where n is the number of fundamental fractal divisions per plate and m is the number of plates, such that four fractal plates provide a total of 1296 drip points.

For planar geometry the smallest building block of the fractals stems from linear branching starting at the node located in the centroid of the overall shape. The shortest path length from the starting node to the outlet nodes is a straight line. When these fundamental building blocks are combined to form more complex fractal distributor (with the restriction that all outlet nodes are equidistant apart) the paths between the central node (or centroid of the overall shape) to the outlet nodes becomes more complex in order to provide the same path length or fractal geometry. This particular fractal patterning is more fully described in U.S. Pat. No. 6,616,317, previously incorporated by reference.

Although is it recognized that to hold to an exact fractal pattern is not practical, the point in striving for this geometric arrangement is to obtain the same flow path length to each drip point. This allows for a robust distributor design as every flow path is hydraulically equivalent. From a distribution standpoint this allows for large variation in overall flowrates and the capability to handle changes in fluid properties (such as viscosity) while maintaining equid distribution per point.

Therefore the object of the present invention is to provide a single fractal distributor which distributes two fluids independently up until they are combined at the final outlets. This is allowed by providing independent fractal flow channels up until reaching the final drip points of the last layer of fractal plates.

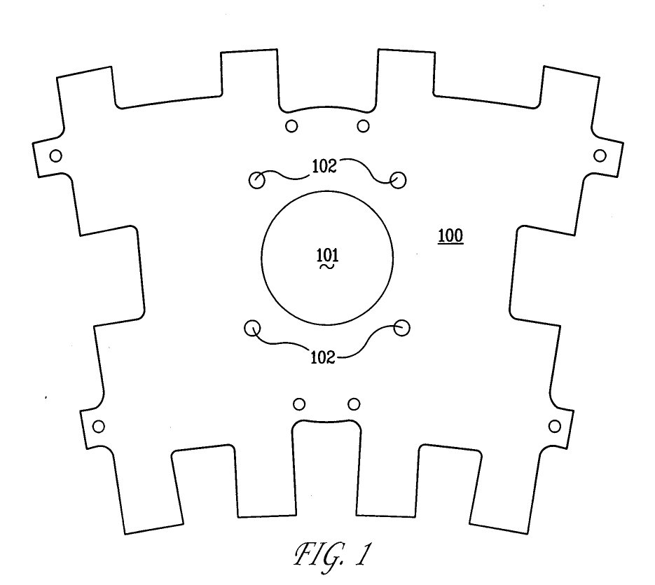

For general construction of fractal plates the reader is referred to U.S. Pat. No. 6,661,317. One section of fractal plates shaped as a pie wedge is shown in FIGS. 1-12. The particular fractal plates have been designed such that the problem of interference between inlet piping for two phases is minimized. The first phase in the illustrated case is a viscous fluid, sulfuric acid, and the second phase is a hydrocarbon phase, comprising isobutane and butylenes. The final mixing occurs in the last plate, wherein the sulfuric acid enters from the top and the hydrocarbon enters from the bottom.

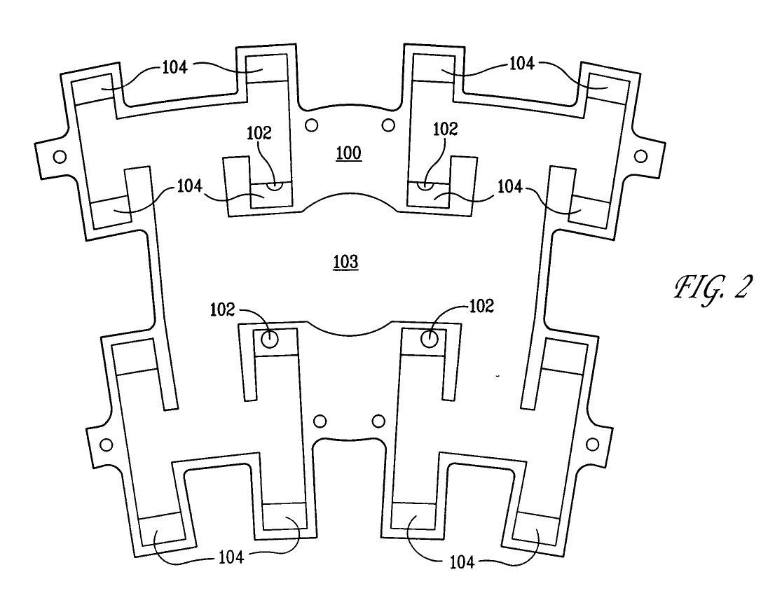

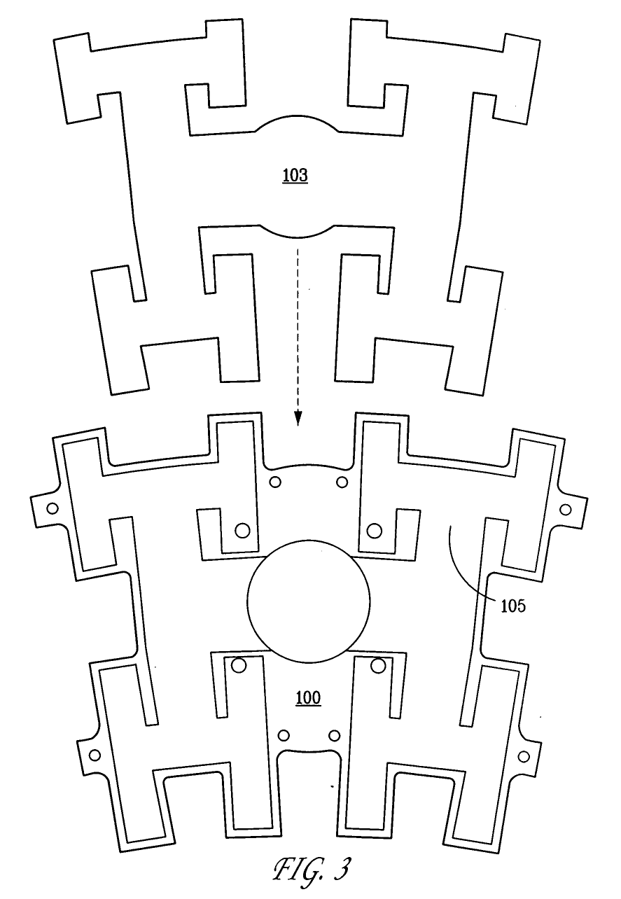

Referring now to the figures, a preferred embodiment includes three plates: 1) an acid (or highly viscous fluid) predistribution plate; 2) a final acid distribution plate and 3) a hydrocarbon distribution plate. Both feeds enter the vessel from above and then must be connected to their respective inlets. In FIG., 1 the acid predistribution plate 100 is shown from the top. The acid inlet is shown at 101. The holes 102 are for bolts that hold the plates together. FIG. 2 shows the acid predistribution 100 plate from the bottom. Insert 103 covers the flow channels from the inlet to the initial drip points 104. In FIG. 3, the insert 103 has been removed exposing the flow channels 105 and the inlet 101.

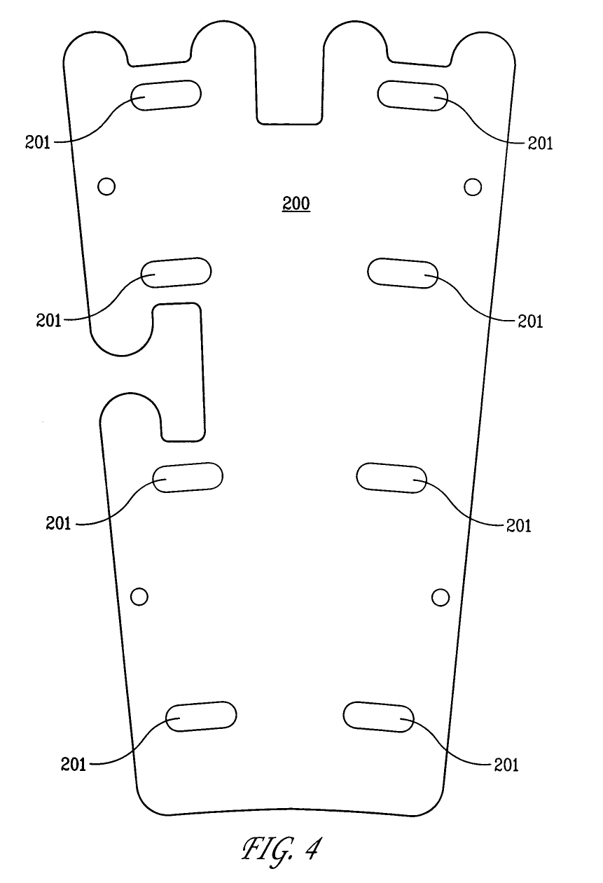

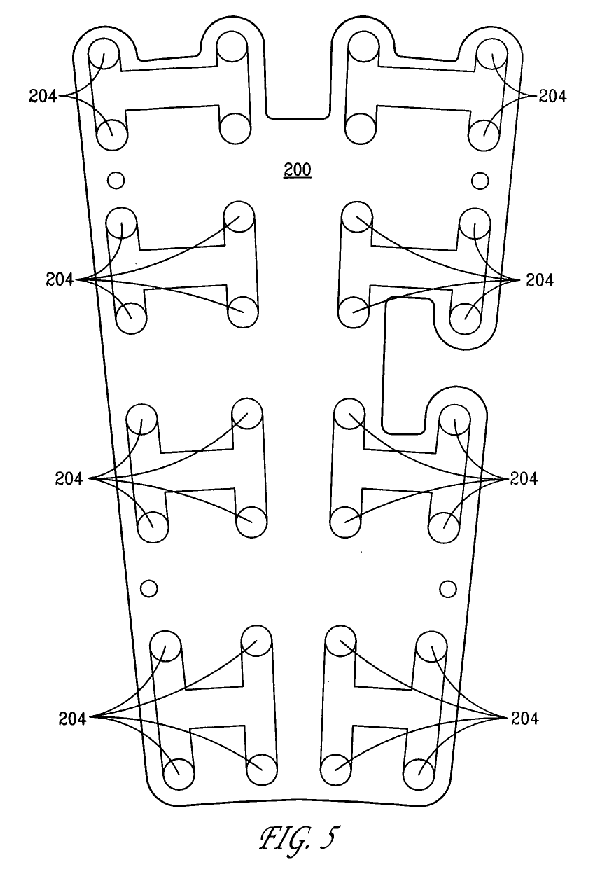

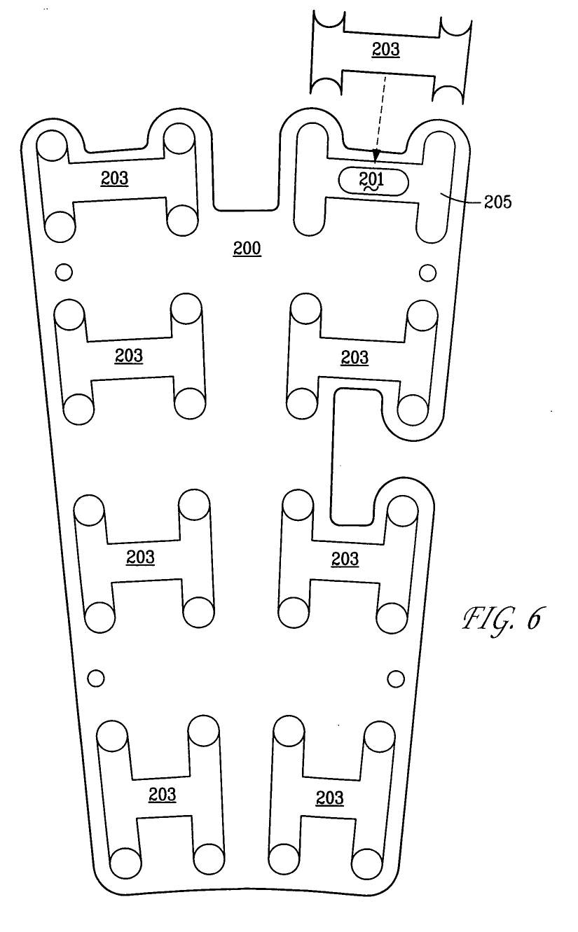

Referring now to FIGS. 4-6, the final acid distribution plate 200 is shown. In use, there are two final acid distribution plates 200 for each acid predistribution plate 100. Each final acid distribution plate has eight inlets 201, which match up to each of the initial drip points 104 on the predistribution plate 100 when assembled. FIG. 5 shows a bottom view of the final acid distribution plate 200 which shows the final drip points 204. In FIG. 6, the a bottom view of the final acid distribution plate 200 is shown with one of the inserts 203 removed, which exposes the flow channels 205.

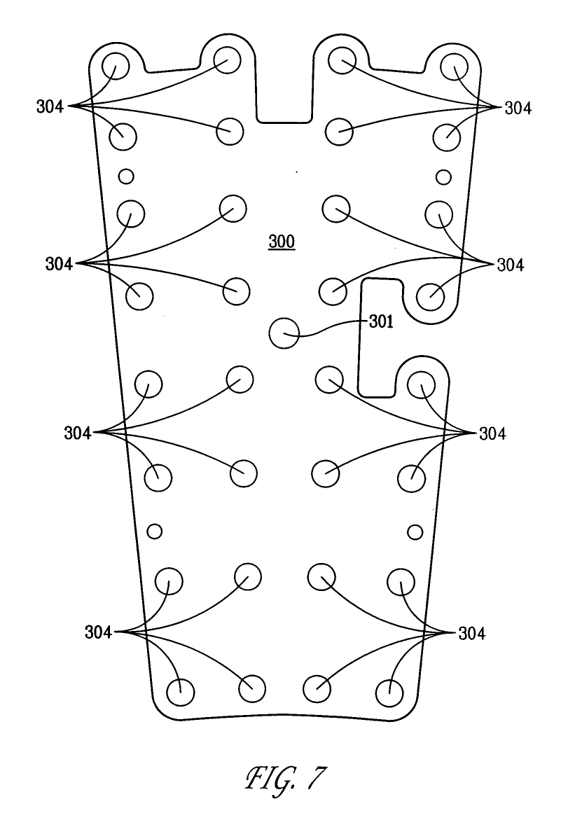

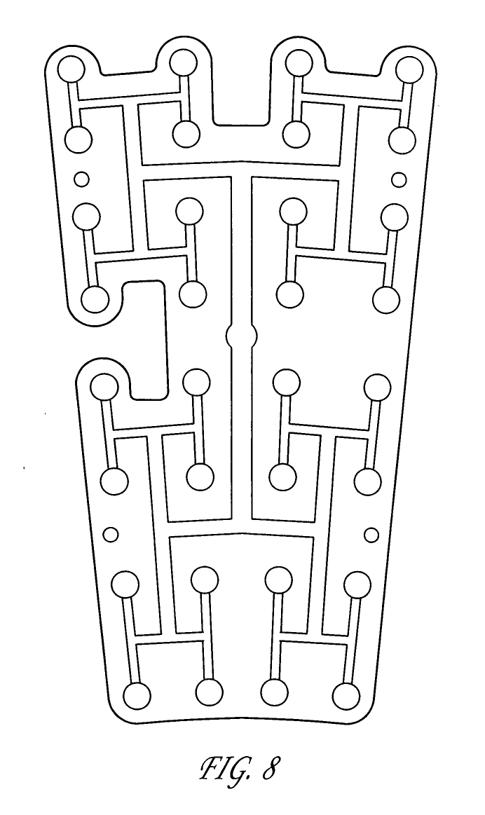

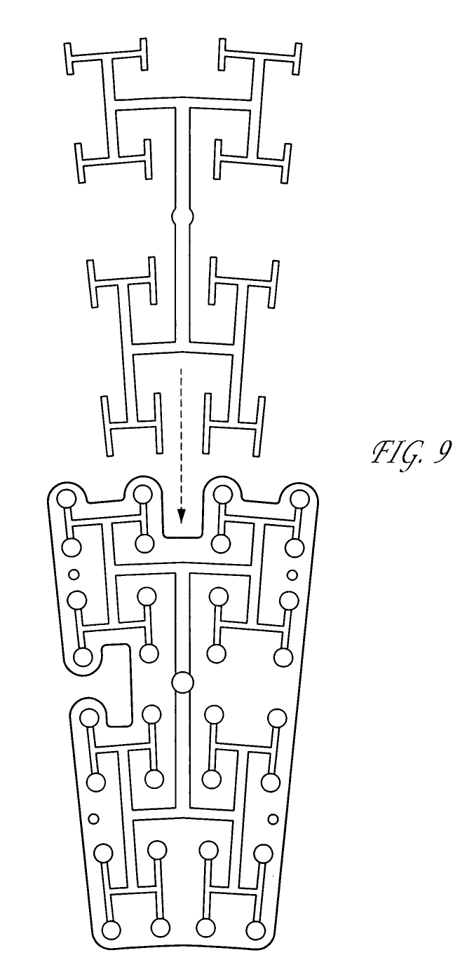

Referring now to FIGS. 7-9 the hydrocarbon distribution plate 300 is depicted. In FIG. 7, a bottom view, the hydrocarbon inlet is shown at 301. There is one hydrocarbon distributor plate 300 per each final acid distribution plate 200. The final outlets or drip points for the acid/hydrocarbon mixture are shown at 304. FIG. 8 depicts the hydrocarbon distribution plate 300 from above with the acid inlets 306 which match up to each of the final acid drip points 204. Insert 303 covers flow channels 305, which can be seen in FIG. 9. The hydrocarbon enters through inlet 301 and mixes with the acid in flow channels 305 and the mixture exits through final drip points 304 into reactor.

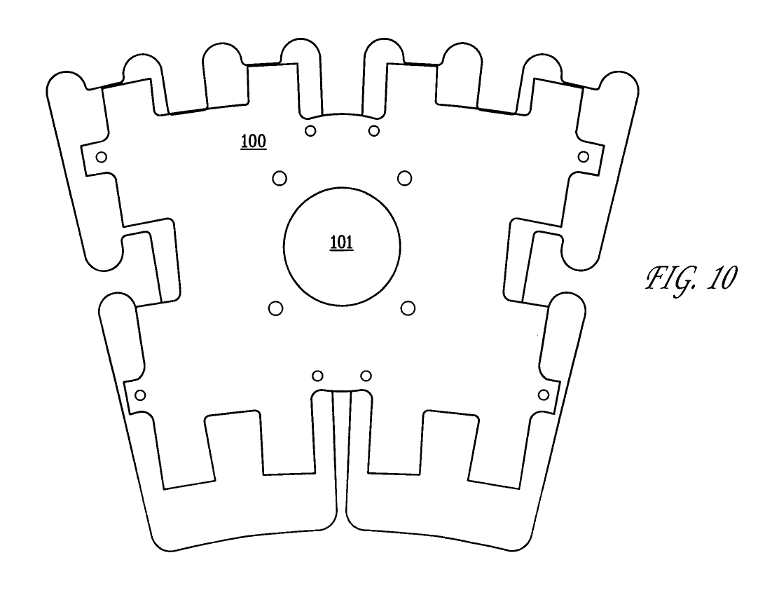

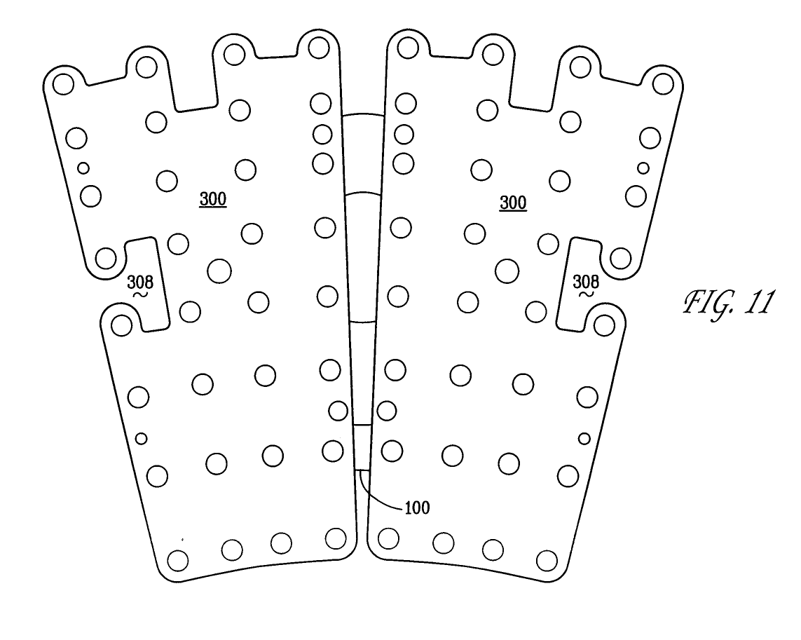

FIGS. 10 and 11 depict a top and bottom view of the assembled plates respectively. Spaces 308 on either side of the assembled plates are for the hydrocarbon inlet piping. The stack shown represents one section of the outer circumference of a vessel having circular cross section of 14.5 ft.

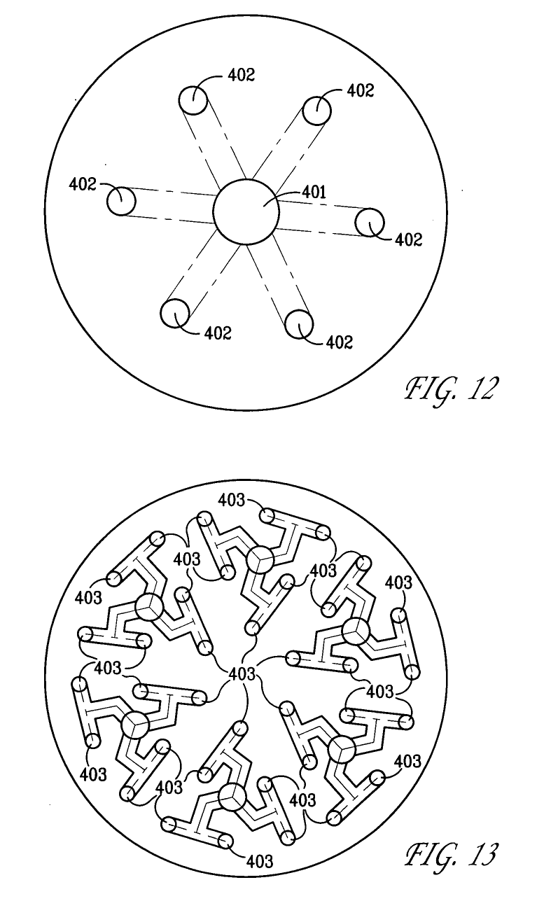

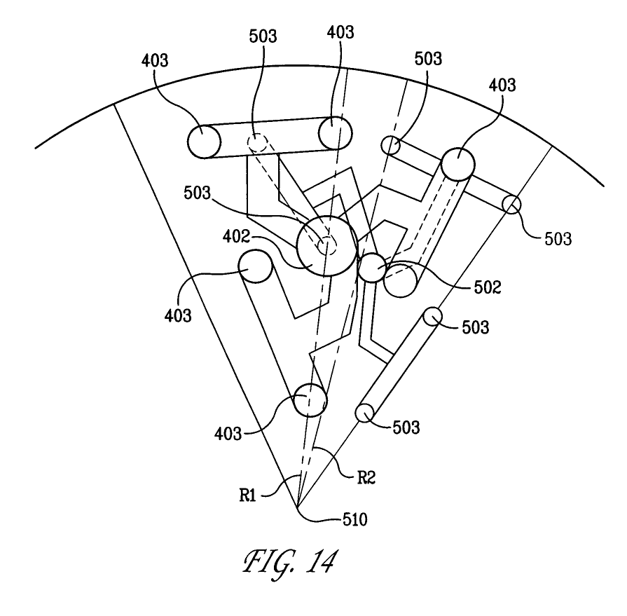

Referring now to FIGS. 12 and 13, the inlet piping for the acid and hydrocarbon is shown. The inlet piping includes a single down spout 401 for each phase which branches into six down spouts 402, each of which branches into six more outlets 403. These outlets are connected to the acid inlet or hydrocarbon inlet on the plate assembly. The inlet is thus fractally branched. The meaning of term “fractally” in this context is “having an equal flow path”. Each branch is a fractal or division. Also, in this context a “fractality” is the point of division.

The problem to get the hydrocarbon inlet piping to the hydrocarbon inlets 301 without the piping interfering with final outlet drip pattern is solved by bring the hydrocarbon inlet piping in overhead along with the acid inlet piping. The hydrocarbon inlet piping, after splitting into 6 overhead pipes, is then passed through spaces 308 at the edge of the plate assemble section and connected to the inlet without passing near or through final drip points 304.

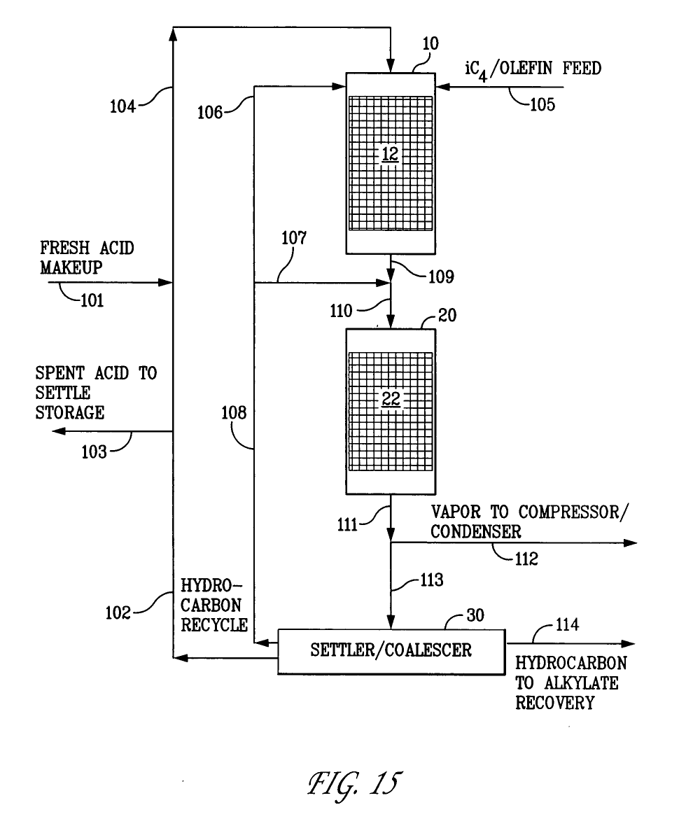

Referring now to FIG. 14, the penultimate down spout 401 of the acid is located central to a wedge 501 of six plate assemblies on a first radius R1. To place the final six downward pipes, or final fractality, of the hydrocarbon inlet pipes 503 over the spaces 308, the radius R2 on which the penultimate down spouts 502 are located, must be rotated around a central axis 510 1/18 of 2Π radians (20°) from that of the radius R1, on which the penultimate acid down spouts 402 are located for this particular configuration. As can be seen from FIG. 14, each of the final hydrocarbon down spouts 503 are located on the center of an edge of a plate assembly which corresponds to the location of the spaces 308.

Although three sets of plates are used to illustrate the invention, the first two plates only provide for acid distribution. Only one is used for hydrocarbon distribution. One plate could have been used for the acid distribution. It is contemplated that two plates is the lowest number of plates for mixing two different liquids and many plates in some applications.

The invention claimed is:

1. A fractal fluid distribution system comprising:
a plurality of first plates, each of said first plates having a first inlet in the approximate geometric center thereof and connected to at least two first outlets by first flow paths having approximate equal length;
a plurality of second plates stacked below said plurality of first plates, each of said second plates having second inlets in communication with said first outlets, each of said second inlets connected to at least two second outlets by second flow paths having approximate equal length, each of said second plates having a third inlet in the approximate geometric center and connected to each of said second flow paths; said plates being offset from one another by rotation around a central axis;
a first conduit central to said vessel having a plurality of second conduits fractally connected to each of said first inlets; and
a third conduit central to said vessel having a plurality of fourth conduits fractally connected to each of said third inlets.

2. The fractal fluid distribution system according to claim 1 arranged in a vessel.

3. The fractal fluid distribution system according to claim 2 arranged in a cylindrical vessel.

4. The fractal fluid distribution system according to claim 3 wherein said first and second inlets are on the upper surface of said plates and said third inlet is on the lower surface of said second plate.

5. The fractal fluid distribution system according to claim 4 wherein the final fractality of said second plurality of conduits is offset from the first fractality of said plurality of conduits such that each of said fourth plurality of conduits pass between said stacks of said first and second plurality of plates.

6. The fractal fluid distribution system according to claim 5 wherein there are more than 2 pluralities of plates stacked together.

7. The fractal fluid distribution system according to claim 1 wherein said first and second inlets are on the upper surface of said plates and said third inlet is on the lower surface of said second plate.

8. The fractal fluid distribution system according to claim 4 wherein the final fractality of said second plurality of conduits is offset from the first fractality of said plurality of conduits such that each of said fourth plurality of conduits pass between said stacks of said first and second plurality of plates.

9. The fractal fluid distribution system according to claim 1 wherein there are more than 2 pluralities of plates stacked together.
